(19) United States
(12) Patent Application Publication
(10) Pub. No.: US 2025/0132996 A1
(43) Pub. Date: Apr. 24, 2025

(54) ACTIONABLE AND INTERACTIVE LOG VISUALIZATIONS

(71) Applicant: Cisco Technology, Inc., San Jose, CA (US)

(72) Inventors: Sofia Karygianni, Dubendorf (CH); Yannick Weibel, Lausanne (CH); Carlo Zapponi, Milano (IT)

(21) Appl. No.: 18/381,842

(22) Filed: Oct. 19, 2023

(51) Int. Cl. H04L 43/045; H04L 43/028

(52) U.S. Cl. CPC H04L 43/045; H04L 43/028

(57) ABSTRACT

In one implementation, a method is disclosed comprising: determining, by a process, a log template mapped from network monitoring log messages; generating, by the process, a visualization of the log template including interactive graphical representations of a detection frequency for the log template, a frequency distribution of parameter values per parameter for the log template, and relationships between parameter values across different parameters for the log template; filtering, by the process, data included in the visualization based on a user selection of a portion of a particular graphical representation; and modifying, by the process and based on user feedback on the visualization, generation of subsequent visualizations of log templates.

### TECHNICAL FIELD

The present disclosure relates generally to computer systems, and, more particularly, to actionable and interactive log visualizations.

### BACKGROUND

In the era of modern network devices and computing systems, copious amounts of log data are continuously being generated. The sheer volume of these logs has rendered manual wholesale inspection of this data infeasible. At the same time, automatic analysis and categorization is also challenging. For example, while the logs frequently include some well-defined fields, their most informative part is contained in a “free form” text field called the ‘message’. This message is a parametrized text defined by a programmer. While part of the message is constant, i.e., the template, the parametric portion can be and often is different in every log message. Automated log analysis is unable to consistently identify a coherent structure within the diversity of different templates and their ever-changing parameters.

Even if a method can successfully facilitate the automatic extraction of log templates and their parameters, a necessary step in effective log analysis, this is not enough to arrive at coherent and informative log characterizations by itself. Therefore, a comprehensive and interactive visualization of log data that facilitates a user's understanding the evolution of logs and their parameters across time is not achievable with the currently available log monitoring tools. Consequently, the performance of computing devices and data communication networks such as those involved in executing the log monitoring process as well as those subject to the log monitoring is adversely impacted.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example of an architecture for providing actionable and interactive log visualizations;

FIGS. 5A-5G illustrate examples of actionable and interactive log visualization and various modifications thereof; and

FIG. 6 illustrates an example simplified procedure for generating and adapting actionable and interactive log visualizations.

### DESCRIPTION OF EXAMPLE EMBODIMENTS

### Overview

According to one or more implementations of the disclosure, a method is introduced herein that facilitates the production and use of actionable and interactive log visualizations. The method may include determining a log template mapped from network monitoring log messages, generating a visualization of the log template, filtering the data included in the visualization based on user selections, and modifying generation of subsequent visualizations of log templates based on user feedback. An actionable and interactive log visualization may result which then may be utilized for log message monitoring operations.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

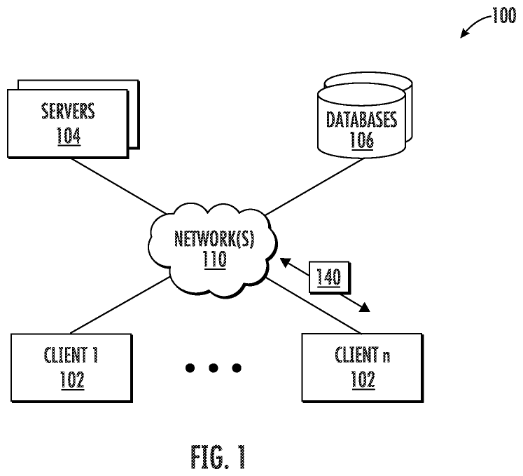

FIG. 1 is a schematic block diagram of an example simplified computing system 100 illustratively comprising any number of the client devices 102 (e.g., a first through nth client device), one or more of servers 104, and one or more of databases 106, where the devices may be in communication with one another via any number of networks (e.g., networks 110). The one or more networks (e.g., networks 110) may include, as would be appreciated, any number of specialized networking devices such as routers, switches, access points, etc., interconnected via wired and/or wireless connections. For example, devices 102-104 and/or the intermediary devices in network(s) (e.g., networks 110) may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) (e.g., networks 110).

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in simplified computing system 100, and that the view shown herein is for simplicity. Also, those skilled in the art will further understand that while the network is shown in a certain orientation, the simplified computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

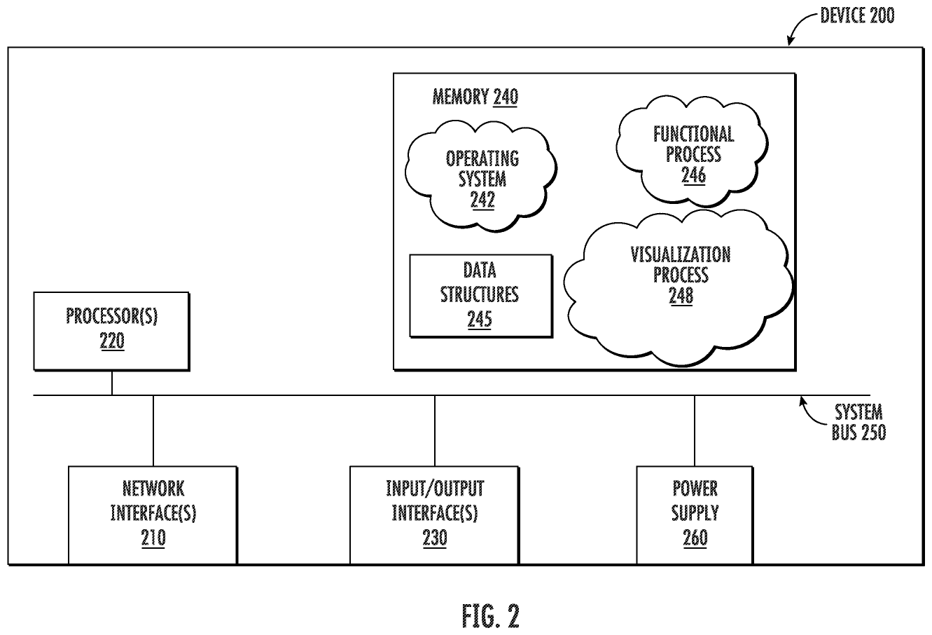

FIG. 2 is a schematic block diagram of an example node/device 200 that may be utilized with one or more implementations described herein, e.g., as any of the devices 102-106 shown in FIG. 1 described above as well as the present disclosure described below. Device 200 may comprise one or more network interfaces (e.g., network interfaces 210) (e.g., wired, wireless, etc.), at least one processor (e.g., processor 220), and a memory 240 interconnected by a system bus 250, as well as a power supply 260 (e.g., battery, plug-in, etc.).

The network interface(s) (e.g., network interfaces 210) contain the mechanical, electrical, and signaling circuitry for communicating data over links coupled to the network(s) (e.g., networks 110). The network interfaces may be configured to transmit and/or receive data using a variety of different communication protocols. Note, further, that device 200 may have multiple types of network connections via network interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise one or more of functional processes 246, and on certain devices, a visualization process 248, as described herein. Notably, functional processes 246, when executed by processor(s) (e.g., processor 220), cause each particular device (e.g., device 200) to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

### ——Observability Intelligence Platform——

Distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more implementations herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

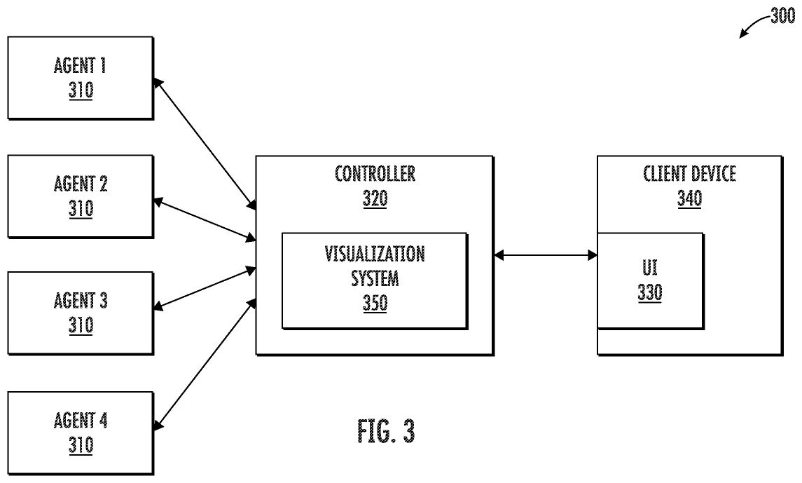

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable implementation of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more of agents 310 and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller(s) (e.g., controller 320) as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) (e.g., interface 330) that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, a controller instance (e.g., controller 320) may be hosted remotely by a provider of the observability intelligence platform 300. In an illustrative on-premises (On-Prem) implementation, a controller instance (e.g., controller 320) may be installed locally and self-administered.

Controllers 320 receive data from different agents (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one implementation, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain implementations, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The data may be captured as, delivered as, and/or generated from data logs. Each data log may include logged data surrounding a computing and/or network event. Each data log may be generally conceptualized as being made up of a combination of a constant/repeating portion (e.g., a log template) and a variable portion (e.g., a parametric portion). For instance, a data log such as User ‘Alice’ logged in from IP address ‘192.168.1.100’ may include a template such as User ‘X’ logged in from IP address ‘Y’ having two parameters ‘X’ and ‘Y’ whose values represent the username and IP address, respectively.

The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

### ——Actionable and Interactive Log Visualizations——

As noted above, modern methods for automatic extraction of log templates and/or their parameters are unable to produce comprehensive and interactive visualizations on top of the logs. Consequently, users are unable to achieve a sufficient understanding of the evolution of logs and their parameters over time. For example, with these methods there is no way to visualize the distribution of the parameters across time nor their joint distribution. Logs cannot be filtered based on their parameters and there is also no option to compare log distributions across different time windows. The result is degraded network and device performance as a result of attempts to inefficiently process the vast amounts of log messages and as a result of delayed or prevented identification and/or remediation of problems affecting the network or device performance.

In contrast, the techniques herein introduce automated mechanisms for generating actionable and interactive data visualizations from free form messages such as logs. These mechanisms facilitate extraction of parametric portions of log messages which are then used to visualize parameter distribution, correlate values between the parameters, and compare the messages across different time periods. The interactivity and visualization functionalities of these mechanisms facilitate effective message filtering and user analysis of huge amounts of log data. These mechanisms extend well beyond simple template and parameter histograms, instead providing user users the freedom to interact with log visualization and choose what they want to focus on and at what depth. For example, the users can select both the time and parameter space that they want to focus on, they can delve into the joint distribution of the parameters, and they can compare those joint distributions on different time windows. They can also choose which parameters they want to focus their analysis on and even customize the visualization by providing custom parameter names and/or templates. The result is actionable and interactive log visualization that is iteratively improved with feedback and which improves network and device performance by simplifying the process of visualizing and interpreting the vast amounts of log messages and enabling and accelerating the identification and/or remediation of problems affecting the network or device performance.

Illustratively, the techniques described herein may be performed by hardware, software, and/or firmware, such as in accordance with visualization process 248, which may include computer executable instructions executed by the processor 220 (or independent processor of network interfaces 210) to perform functions relating to the techniques described herein.

Specifically, according to various implementations, a method may include determining a log template mapped from network monitoring log messages; generating a visualization of the log template including interactive graphical representations of a detection frequency for the log template, a frequency distribution of parameter values per parameter for the log template, and relationships between parameter values across different parameters for the log template; filtering data included in the visualization based on a user selection of a portion of a particular graphical representation; and modifying, based on user feedback on the visualization, generation of subsequent visualizations of log templates.

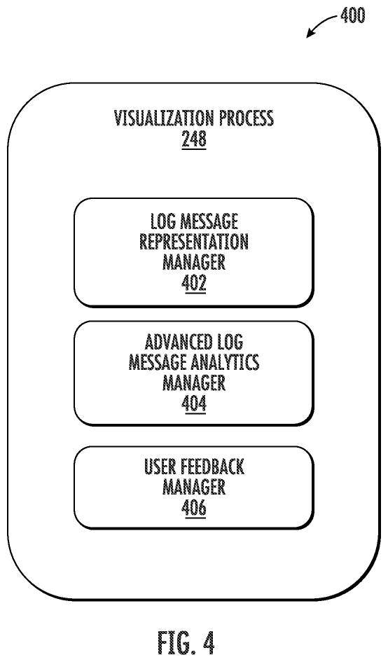

Operationally and according to various implementations, FIG. 4 illustrates an example of an architecture 400 for providing actionable and interactive log visualizations. At the core of architecture 400 is visualization process 248, which may be executed by one or more device. For example, visualization process 248 may be executed by a network controller, an edge device, an IoT device, an IoT controller, an equipment controller, a computing device, a server, cloud computing resources, etc. In various implementations, visualization process 248 may be executed as a part of and/or in association with an observability intelligence platform (e.g., such as observability intelligence platform 300 in FIG. 3).

As shown, visualization process 248 may include lag message representation manager (LMR manager 402), advanced log message analytics manager (ALMA manager 404), and/or user feedback manager (UF manager 406). As would be appreciated, the functionalities of these components may be combined or omitted, as desired. In addition, these components may be implemented on a singular device or in a distributed manner, in which case the combination of executing device can be viewed as their own singular device for purposes of executing visualization process 248.

The components of visualization process 248 may be executable to produce interactive log visualizations that facilitate comprehensive log analysis and parameter driven monitoring. The visualization may be constructed by transforming log messages into analyzable sub-components (e.g., the log template constants and their parameters). This may be accomplished by detecting commonalities across log messages, extracting templates and parametric parts, transforming the extracted template and parametric parts into informative and actionable representations of the system's function, and facilitating user customization of the visualization, the analysis used to produce the visualization, and/or the way that subsequent log messages are analyzed.

When executing, LMR manager 402 may obtain log messages. Obtaining the log messages may include collecting network monitoring log messages from agents or other portions of an observability intelligence platform or other log collection platform.

LMR manager 402 may infer a data model from the collected log message. The data model may be a model that distinguishes between the constant and parametric part of the log messages. As discussed later, this model may be influenced and/or modified by prior executions of visualization process 248 and specifically by user feedback on prior applications of the model and/or their resulting visualizations.

LMR manager 402 may create a map by application of the model to the log messages. For example, LMR manager 402 may create a map between all potential log messages and a reduced set of log representations. The reduced set of log representation may be log templates. These templates may be utilized to represent all instantiations of the collected log messages when supplied with the correct parameters. The templates may be made up of and/or define the repeating, constant parts of the log messages. In contrast, the parameters may include the information that is particular to a specific log message and/or which may vary from log message to log message.

LMR manager 402 may employ any number of machine learning (ML) and/or artificial intelligence (AI) techniques, such as to infer a data model from collected log messages, differentiate between constant and parametric components of log messages, identify and map collected log messages to a reduced set of log representations, etc., as described herein. In addition, ML and/or AI techniques may be utilized with respect to the processes associated with ALMA manager 404 and/or UF manager 406, as well.

In general, machine learning is concerned with the design and the development of techniques that receive empirical data as input (e.g., log messages, herein), recognize complex patterns in the input data, and optionally make adjustments to the data (e.g., segmenting the data into subcomponents, identifying common templates in the data, enhancing the data, filling in missing data, changing the data, transforming the data into 2.5 interactive visualizations, etc.). For example, some machine learning techniques use an underlying model, which is trained to perform certain operations (e.g., classifying data, adjusting data, and so on). A learning process adjusts parameters of the model such that after this optimization/learning phase, the model can be applied to input data sets to perform the desired functionality.

In various implementations, such techniques may employ one or more supervised, unsupervised, or semi-supervised machine learning models. Generally, supervised learning entails the use of a training set of data, as noted above, that is used to train the model to apply labels to the input data. On the other end of the spectrum are unsupervised techniques that do not require a training set of labels. Notably, while a supervised learning model may look for previously seen patterns that have been labeled as such, an unsupervised model may attempt to analyze the data without applying a label to it. Semi-supervised learning models take a middle ground approach that uses a greatly reduced set of labeled training data.

Example machine learning techniques that the techniques herein can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) artificial neural networks (ANNs) (e.g., for non-linear models), replicating reservoir networks (e.g., for non-linear models, typically for time series), random forest classification, deep neural networks (DNNs), or the like.

In various implementations, LMR manager 402 may utilize multiple machine learning techniques around text and natural language processing to implement the above outlined process. For example, LMR manager 402 may utilize or be a parsing tree that encodes in its nodes the constant tokens of the log messages. In this manner, LMR manager 402 may create the set of log templates made up of the repeating, constant parts of the log messages while the parameters are the information that is particular to a specific log message.

When executing, ALMA manager 404 may generate a comprehensive visualization of the log messages and their evolution across time. This visualization may be interactive and adaptable to user feedback. As such, this visualization may facilitate a user in analyzing the logs, monitoring the system, and/or improving future log analysis and models underpinning the same.

For example, for each log template determined from the collected log messages, the ALMA manager 404 may generate a visualization providing an overview of the frequency of the template across time, as well as the evolution of the template parameters during the same period. For instance, the visualization generated by ALMA manager 404 may include interactive graphical representations of a detection frequency for the log template, a frequency distribution of parameter values per parameter for the log template, relationships between parameter values across different parameters for the log template, and/or a log message table listing log message data.

In various implementations, the visualization generated by ALMA manager 404 may represent each log template parameter in two ways. First, as a frequency graph over the parameter values in an inspected time window and second as an axis with the unique parameter values in a parameter parallel coordinate chart (PCC). The PCC may connect the values across different parameters and thus facilitate easy inspection and/or identification of which parameter combinations were present in the log messages and at what frequency. The frequency of the parameter combinations may, in some instances, be shown through the thickness of the lines connecting the different parameter values in the PCC. In addition, ALMA manager 404 may include a table displaying the complete logs corresponding to a time and parameter selection by a user.

When executing, UF manager 406 may automatically process and act on user feedback. As previously outlined, the visualization may be interactive. For instance, the visualization may be configured to receive and/or adapt to user feedback. In some instances, user feedback may be provided by interactions with various parts of the visualization. For example, a user may select one or more data points, values, times, graphical features, graph labels, etc. In response, UF manager 406 may modify the visualization accordingly.

For example, by selecting a portion of interest within the visualization, the visualization may be modified to facilitate the user in drilling down on any dimension of the data that they are interested in. The modification may include filtering data, reorganizing data, changing data, revising graphical representations, highlighting data and/or graphical representations, removing or deemphasizing data and/or graphical representations, etc. If, for example, a user chooses a custom time window of interest, then the visualization may be modified to highlight and/or display only the data associated with that time window. Likewise, if a user chooses a particular parameter value of interest or a set of parameter values of interest, then the visualization may be modified to highlight and/or display only the data associated with those parameter values. These modifications may be caused to occur in substantially real time (e.g., as soon as possible and/or immediately in response to the user feedback) such that user selections operate as a cross filter and the visualizations highlight in real time how the filter reflect on the data.

Moreover, user feedback may include user customizations. For example, a user may provide custom names for displayed parameters, a custom visualization layout, a custom template and/or parametrization, a modification of an existing template and/or parameterization, a custom time window, a custom parameter set, etc. These customizations may be utilized by UF manager 406 to modify the visualizations. In addition, UF manager 406 may modify and improve the functionality, inputs, models, computations, etc. of LMR manager 402 and/or ALMA manager 404 based on the customization such that the current visualization and/or subsequent visualizations (later visualizations based on the same or different log message data) incorporate those customizations and/or better align with user preferences.

Furthermore, user feedback may include user ratings. For example, a user may provide a rating (e.g., a numerical rating, a star rating, a thumbs up/down rating, etc.) of each template, parameterization, visualization, etc. This rating may then be utilized by UF manager 406 to modify and improve the functionality, inputs, models, computations, etc. of LMR manager 402 and/or ALMA manager 404 based on the ratings such that the current visualization and/or subsequent visualizations take into account these ratings and/or better align with user preferences.

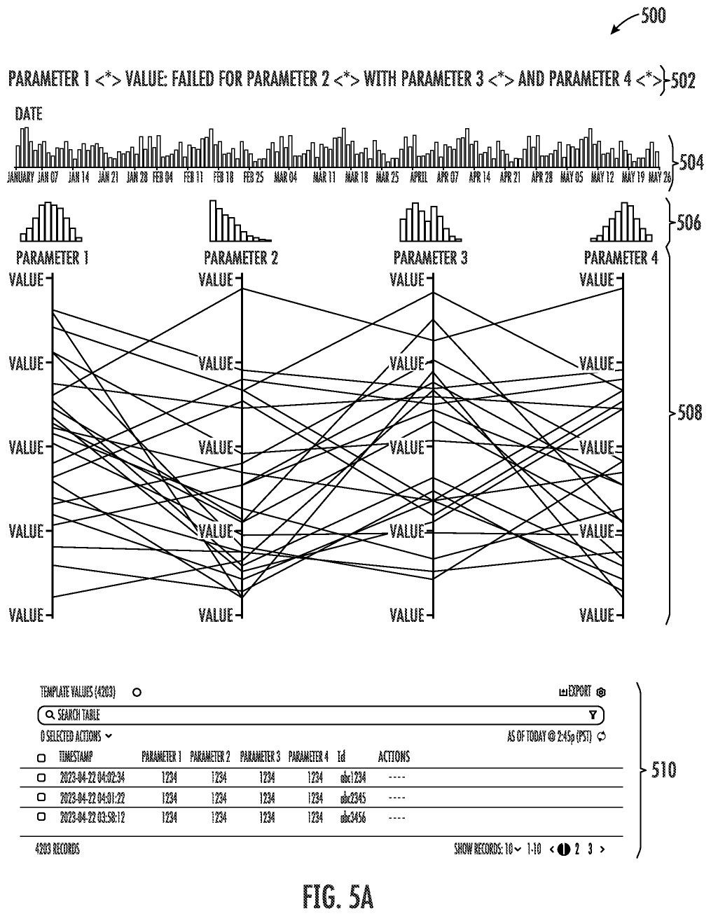

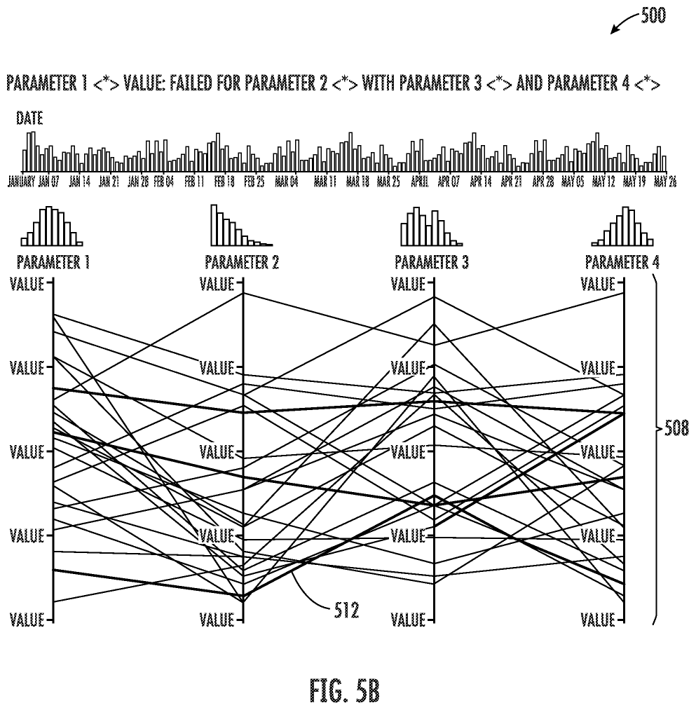

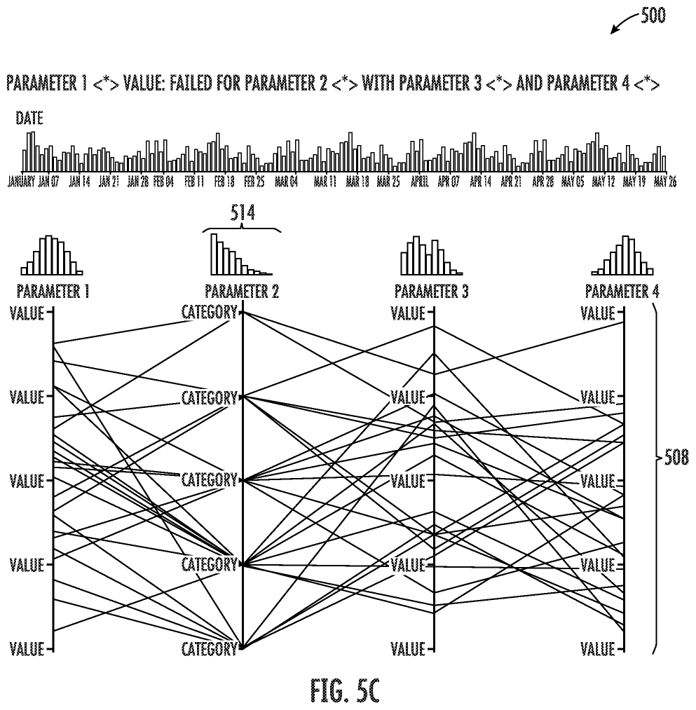

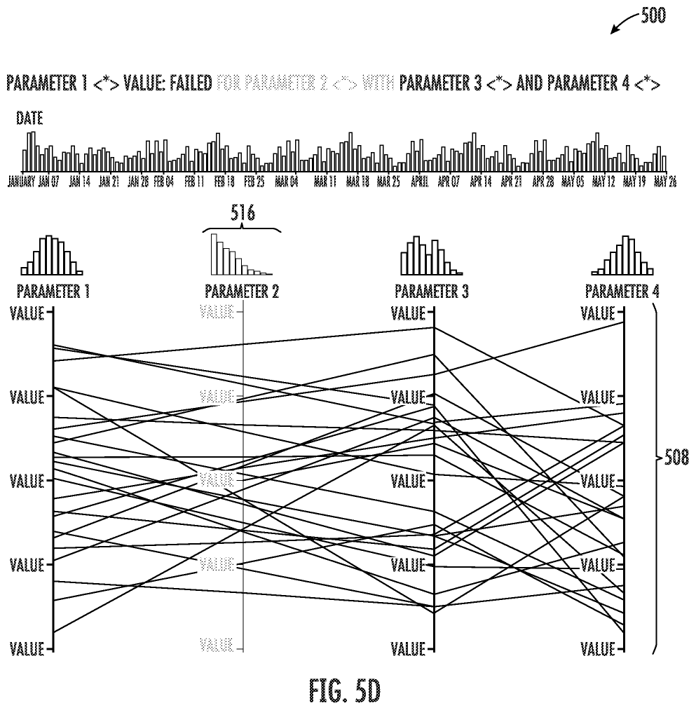

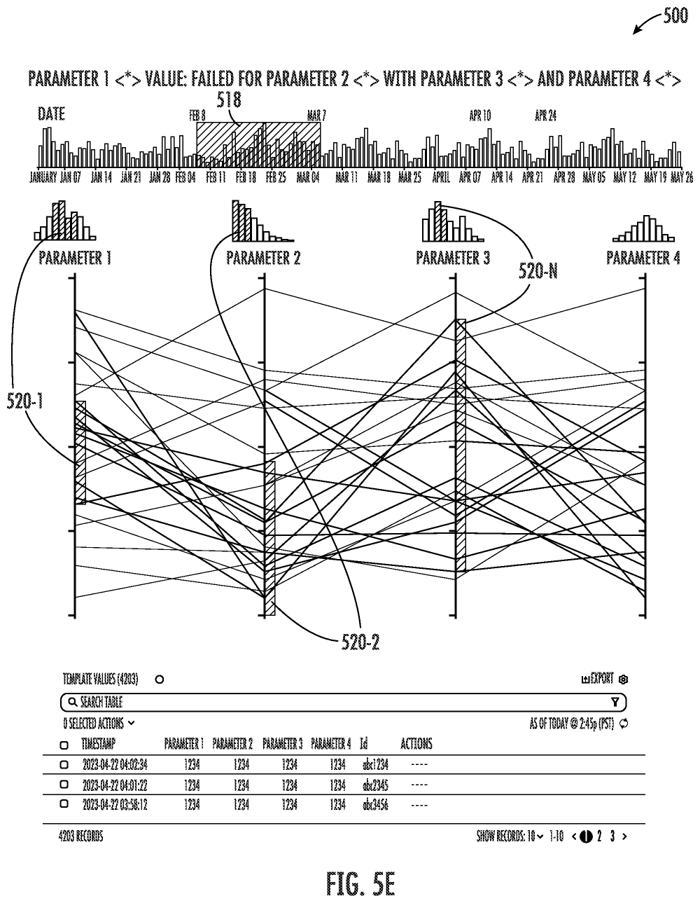

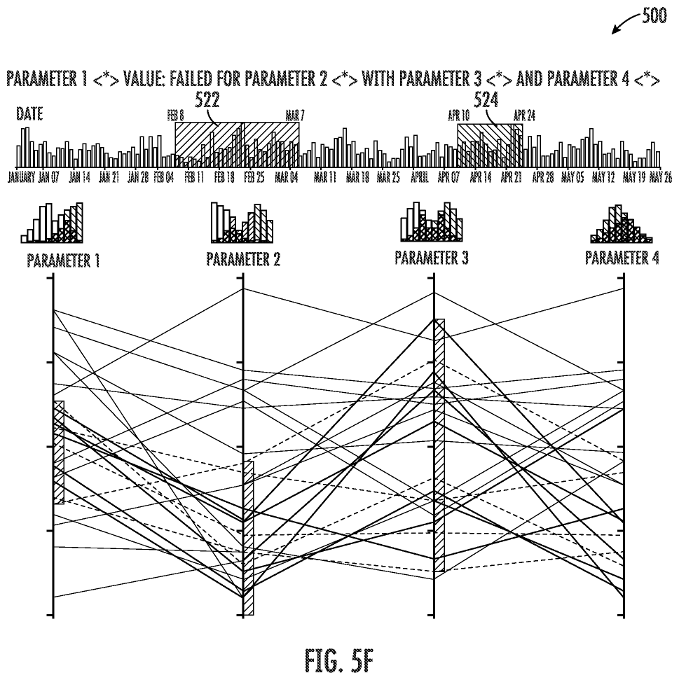

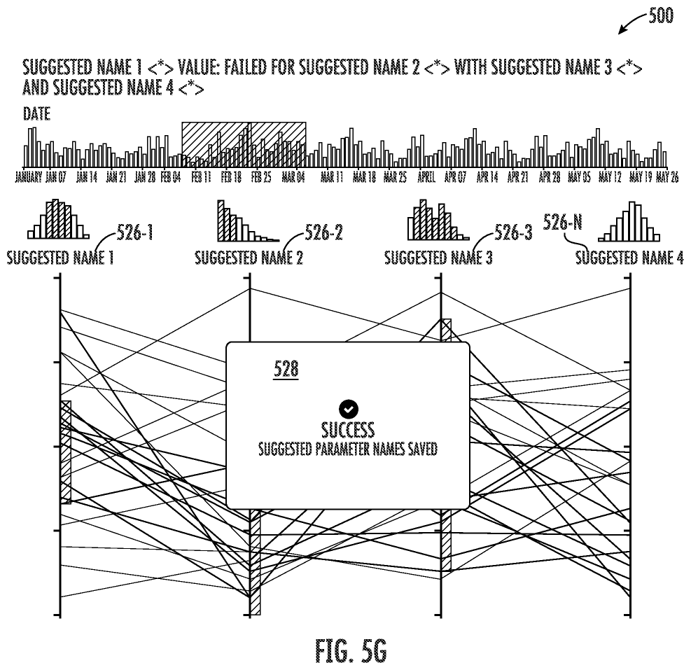

FIGS. 5A-5G illustrate examples of actionable and interactive log visualization and various modifications thereof based on user interaction, in accordance with various implementations herein. The visualizations may be generated by execution of a process such as visualization process 248. The visualizations may be presented to a user via a user interface of an observability intelligence platform (e.g., such as observability intelligence platform 300 in FIG. 3). These visualizations may be utilized to monitor network conditions and identify the cause of and/or potential resolutions for network problems.

For example, FIG. 5A illustrates a visualization 500 that provides a set of graphical representations of the log template evolution across time. This may be a default view presented for a log template that provides an overview of the frequency of that log template across time as well as the evolution of the template parameters during the same period.

In various implementations, a template definition 502 may be part of visualization 500. The template definition 502 may include a label expressing the parameters expressed in the visualization 500. As with the other portions of the visualization 500, the template definition may be modified to include or exclude portions of the definition in response to user feedback indicating the change.

In addition, visualization 500 may include a template detection frequency graph 504. The template detection frequency graph 504 may be a graphical expression of a daily count (e.g., per day) of the detected occurrences of the log template. In some instances, this may include a bar chart segmented by day or other period of time.

Visualization 500 may also include a parameter frequency distribution graph 506. The parameter frequency distribution graph 506 may include a graphical representation (e.g., bar chart, etc.) depicting the distribution of parameter values per parameter for the log template.

In various implementations, visualization 500 may include a parameter relationship graph 508. The parameter relationship graph 508 may include a graphical representation of the relationships between parameter values across different parameters for the log template. The parameter relationship graph 508 may be a parameter parallel coordinates chart (PCC). The PCC may show both the distribution per parameter value as well as the distribution across the different parameters, thereby offering a comprehensive summary view of the log messages.

Additionally, visualization 500 may include a log table 510 log table with entries for each of the network monitoring log messages included in the visualizations. The log table 510 may display the complete logs corresponding to any of the time and parameter selections made by the user as well. Log table 510 is also adaptable to user feedback such that it is automatically updated to include only the log messages that are associated with regions of interest (e.g., time windows, parameter value windows, etc.) as indicated by the users.

FIG. 5B illustrates an example of a cropped and zoomed version of visualization 500 that better illustrates graphical features of parameter relationship graph 508. Specifically, this view illustrates differentiating variation in graphical properties of the connecting elements 512 of the PCC. The PCC connects the values across different parameters and thus allows the user to easily inspect which parameter combinations were present and at what frequency. Here, the thickness of the connecting elements 512 is correlated to and, consequently, represents the frequency of the parameter combinations of the different values that they connect.

FIG. 5C illustrates an example of visualization 500 adapted to a categorical parameter 514. The parameters displayed can be either numeric or categorical, and the presently disclosed techniques can determine whether a parameter is numeric or categorical automatically and adjust the view accordingly. Here, the PCC portion of visualization 500 is illustrated adjusted to the determination of “Parameter 2” as a categorical parameter 514.

FIG. 5D illustrates an example of visualization 500 adapted to user feedback indicating that a particular parameter is an irrelevant parameter 516. When a parameter is irrelevant to the analysis the user is conducting, that parameter axis can be disabled or deactivated in the visualization 500 as well as in the template definition. The data associated with the irrelevant parameter 516 may be removed from and/or deemphasized (e.g., given a particular color, shading, transparency, etc.) in the visualization.

FIG. 5E illustrates an example of visualization 500 adapted to user feedback selecting regions of interest within the graphical representations. For instance, user feedback may include a selection of a custom time window 518 and/or a custom parameter value window 520 (e.g., 520-1 . . . 520-N). These selections may be used to modify the focus of the visualization 500. For example, all data shown on the page, including in the log table, may be filtered according to the selected regions of interest.

For instance, the user can highlight specific time windows and/or parameter ranges by selecting the corresponding areas of the charts in visualization 500. Here, the selection of specific parameter values for parameters 1, 2 and 3 on a specific time window is used to highlight the relevant edges in the PCC, thereby facilitating the inspection of the corresponding logs. Also, the log table is updated to depict only the relevant logs.

FIG. 5F illustrates an example of visualization 500 adapted to user feedback selecting multiple regions of interest within the graphical representations for comparison. When it comes to selection, the user can also choose two different time windows (e.g., first time window 522, second time window 524) and compare their corresponding logs. The selected time windows may then be colored, shaded, patterned, etc. in distinct manners within the timeline and parameter distributions to differentiate between their respective data. The same visual differentiating scheme may also be applied to the connecting elements in the PCC diagram. This way, the user can easily spot the differences in the logs of each window in any parameter dimension or their combinations.

For instance, visualization 500 is modified with the visual differentiating scheme configured for a log comparison for two different time windows. Each window is configured with a distinct appearance, and the parameter distribution diagrams as well as the PCC diagram are configured to highlight the parameter values and combinations observed in each window accordingly.

FIG. 5G illustrates an example of visualization 500 adapted to a user customization. As previously noted, the user has the option to customize the logs depicted by providing additional names for the displayed parameters. Often, after interacting with the log data for some time, the users get a better understanding of the parameters displayed. In such cases, they might want to provide custom names 526 (e.g., 526-1 . . . 526-N) that make sense for their system and would facilitate greater efficiency in future monitoring operations. The users can suggest the custom names 526 through the text fields under the parameter histograms. Custom names 526 may complement the names already provided by the visualization system. In various implementations, the visualization 500 may briefly display a confirmation 528 to the user confirming that the customization was accepted.

Additional user customizations may include user ratings. User ratings may include an expression of the user's satisfaction with all or some portion of the visualization. For instance, a user rating may include a user generated score of components and/or the overall quality or usefulness of the visualization. In some instances, this may include user ratings of each template and parametrization. Additional user customizations may include modifications of an existing template and parametrization, customized templates and parametrizations, etc. Regardless of the format of the customization, it may be used to improve one or both of LMR manager components and/or ALMA manager components of the visualization system.

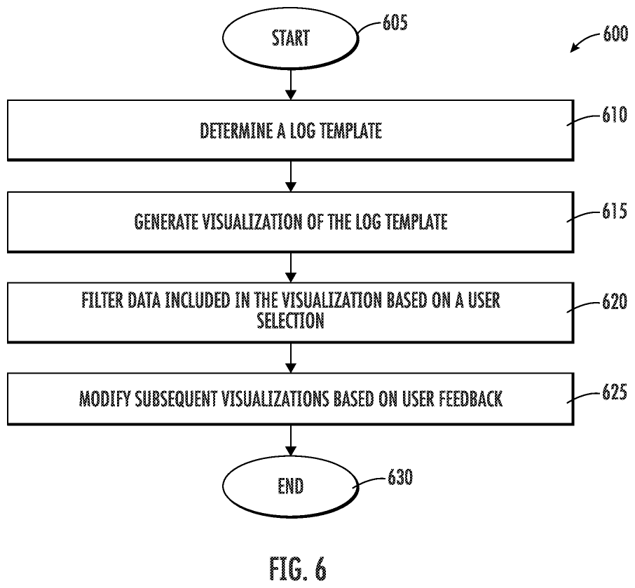

FIG. 6 illustrates an example simplified procedure for generating and adapting actionable and interactive log visualizations, in accordance with one or more implementations described herein. For example, a non-generic, specifically configured device (e.g., device 200) may perform procedure 600 by executing stored instructions (e.g., visualization process 248). Procedure 600 may start at step 605, and continues to step 610, where, as described in greater detail above, a log template mapped from network monitoring messages may be determined.

This may include identifying and creating structured templates that represent the essential components and patterns within a collection of log messages generated by network devices or systems. Determining a log template mapped from network log messages may involve creating a structured format for log data, associating log messages with the appropriate template, and using this structure to facilitate log analysis and management. This process is typically part of log management and analysis, especially in the context of log aggregation and monitoring systems. This process may facilitate making sense of the vast amount of log data generated by complex network environments.

For example, determining the log template mapped from network monitoring log messages may include processing the network monitoring log messages to determine repeating constant portions across the network monitoring log messages and information that is specific to each network monitoring log message. Further, the repeating constant portions may be identified as the log template and the information that is specific to each network monitoring log message may be identified as parameters of the log template in this determination. In various implementations, an inferential data model may be utilized to analyze the logs and to identify constant and parametric components within network monitoring log messages for log template mapping. The inferential data model utilized to identify constant and parametric components within network monitoring log messages for log template mapping may be modified based on, among other things, user feedback such as customizations, data selection, data classification (e.g., important, irrelevant, etc.), user ratings (e.g., of the log template, of the visualization, of elements of the visualization, of the graphical representations, of the parameters, etc.).

The inferential model may be an ML-based model. In some instances, the identification of the constant and/or parametric potions is based on a parsing tree that encodes nodes of the parsing tree with constant tokens of the network monitoring log messages to create the log template.

At step 615, as detailed above, a visualization of the log template may be generated. The visualization may be made up of one or more interactive graphical representations. For instance, the visualization may include an interactive graphical representation of a detection frequency for the log template. This may include a bar chart illustrating per day occurrences of a particular log template.

In addition, the visualization may include an interactive graphical representation of a frequency distribution of parameter values per parameter for the log template. This may include a bar chart illustrating a distribution of parameter values for each parameter included in the visualization.

In various implementations, the visualization may include an interactive graphical representation of relationships between parameter values across different parameters for the log template. This interactive graphical representation may be a parallel coordinate chart (PCC), in which case a graphical property of connecting elements between the parameter values across the different parameters in the PCC may correspond to a frequency of a corresponding parameter combination in the log template. For example, the thicker the lines connecting the parameter value combinations, the mor frequent that combination is in the log messages. Of course, the thickness of the lines may not be the only example of graphical properties which may also include patterns, colors, and other differentiating properties. The parameter values may be numerical or categorical. Whether the parameter values are numerical or categorical may be automatically detected and the PCC may be adapted accordingly.

In some examples, the visualization may include a log table. The log table may display data from and/or a listing of each of the network monitoring log messages included in the interactive graphical representations. That may mean that the log table may not display log messages that are not of interest. For example, when a user selects a particular set of parameter values, period of times, etc. to analyze, the log message table may exclude data from each of the network monitoring log messages that falls outside of that particular set of parameter values, period of time, etc. That is, the log table included in the visualization may be updated to depict only log message data with parameter values within selected parameter value ranges, the selected time windows, etc.

At step 620, the data included in the visualization may be filtered based on a user selection of a portion of a particular graphical representation. Filtering the data may include selectively displaying specific subsets of data while hiding or excluding others within a graphical representation or visualization. This may include altering the selection or highlighting of relevant data, the exclusion of unwanted data, the modification of criteria for generating the visualizations, etc. For instance, filtering may include disabling, based on the user selection indicating that a particular parameter is irrelevant, a graphical representation of a frequency distribution of a particular parameter value for the log template and a graphical representation of a relationship between parameter values for that particular parameter for the log template.

In another example, the user selection of the portion of the particular graphical representation includes a selection of a region of the particular graphical representation corresponding to a specific time window. In such a case, filtering may include filtering the data included in the visualization includes highlighting a region of another graphical representation that corresponds to the specific time window. That is, a user may select a specific time window of interest on the graphical representation of the detection frequency for the log template and this may trigger a modification of the graphical representation of the frequency distribution of parameter values per parameter for the log template and/or the graphical representation of the relationships between parameter values across different parameters for the log template to adapt its values to only include those within the indicated time range of interest.

Of course, the user selection of the portion of the particular graphical representation may include a selection of parameter value ranges within the particular graphical representation (e.g., the graphical representation of the relationships between parameter values across different parameters for the log template). In that case, corresponding modifications (e.g., only include data associated with those parameter values, etc.) may be made to the other graphical representations accordingly.

In various implementations, the user selections may include selections of multiple regions of interest (e.g., sets of parameter values, time windows, etc.) which the user wants to compare. For example, the user selection of the portion of the particular graphical representation may include a selection of a first region of the particular graphical representation corresponding to a first specific time window and a section of a second region of the particular graphical representation corresponding to a second specific time window. In these cases, a color coding (or other graphical or textual differentiators) that differentiates data associated with the first specific time window from data associated with the second specific time window may be applied to the interactive graphical representations of the detection frequency for the log template, the frequency distribution of parameter values per parameter for the log template, and the relationships between parameter values across different parameters for the log template.

At step 625, as noted above, the process or models by which subsequent visualizations of log templates are modified based on user feedback on the visualization. User feedback may include a user customization of a graphical representation, a user rating of an element of the visualization, a customized log template for log message mapping, etc. Again, this user feedback may be used as the basis for modification of an inferential data model utilized to identify constant and parametric components within network monitoring log messages for log template mapping and/or even as the basis for modification of the appearance (e.g., format, color scheme, labels, etc.) of subsequent visualizations.

In some implementations, problematic trends or data may be automatically identified in the visualizations based on, for example, processing the visualizations with inferential models such as ML based models. Once identified, a user may be automatically notified of the identification by a message and/or by a modification of the appearance of the visualizations. For example, potentially problematic data may be highlighted, and the user may be provided with information describing aspects of the problematic trends or data, why they are problematic, potential sources of the problematic trends or data, suggested remediation efforts to address the problematic trends or data, etc.

Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, facilitate automated mechanisms for generating actionable and interactive data visualizations from free form messages such as logs. These mechanisms facilitate extraction of parametric portions of log messages which are then used to visualize parameter distribution, correlate values between the parameters, and compare the messages across different time periods. The interactivity and visualization functionalities of these mechanisms facilitate effective message filtering and user analysis of huge amounts of log data. These mechanisms give users the freedom to interact with log visualization and choose precisely what they want to focus on and at what depth. In addition, user feedback may be utilized to steer how subsequent visualizations are created, formatted, and/or presented and/or improve the underlying models used in this process. This level of interactivity and iterative model/output improvement can provide faster identification and remediation of problematic conditions identifiable through log data. Consequently, the performance of computing devices and data communication networks such as those involved in executing the log monitoring process as well as those subject to the log monitoring is greatly improved through these mechanisms.

According to the implementations herein, an illustrative method herein may comprise: determining, by a process, a log template mapped from network monitoring log messages; generating, by the process, a visualization of the log template including interactive graphical representations of a detection frequency for the log template, a frequency distribution of parameter values per parameter for the log template, and relationships between parameter values across different parameters for the log template; filtering, by the process, data included in the visualization based on a user selection of a portion of a particular graphical representation; and modifying, by the process and based on user feedback on the visualization, generation of subsequent visualizations of log templates.

In one implementation, an interactive graphical representation of the relationships between parameter values across the different parameters for the log template is a parallel coordinate chart. In one implementation, a graphical property of connecting elements between the parameter values across the different parameters corresponds to a frequency of a corresponding parameter combination in the log template. In one implementation, the visualization of the log template further includes a log table for each of the network monitoring log messages included in the interactive graphical representations. In one implementation, a portion of the parameter values are categorical. In one implementation, the method further comprises disabling, based on the user selection indicating that a particular parameter is irrelevant, a graphical representation of a frequency distribution of a particular parameter value for the log template and a graphical representation of a relationship between parameter values for that particular parameter for the log template.

In one implementation, the user selection of the portion of the particular graphical representation includes a selection of a region of the particular graphical representation corresponding to a specific time window. In one implementation, filtering the data included in the visualization includes highlighting a region of another graphical representation that corresponds to the specific time window. In one implementation, the user selection of the portion of the particular graphical representation includes a selection of parameter value ranges within the particular graphical representation. In one implementation, the method further comprises updating a log table included in the visualization to depict only log message data with parameter values within selected parameter value ranges.

In one implementation, the user selection of the portion of the particular graphical representation includes a selection of a first region of the particular graphical representation corresponding to a first specific time window and a section of a second region of the particular graphical representation corresponding to a second specific time window. In one implementation, a color coding that differentiates data associated with the first specific time window from data associated with the second specific time window is applied to the interactive graphical representations of the detection frequency for the log template, the frequency distribution of parameter values per parameter for the log template, and the relationships between parameter values across different parameters for the log template.

In one implementation, the user feedback includes one or more of: a user customization of a graphical representation; a user rating of an element of the visualization; or a customized log template for log message mapping. In one implementation, the method further comprises modifying, based on the user feedback, an inferential data model utilized to identify constant and parametric components within network monitoring log messages for log template mapping. In one implementation, determining the log template mapped from network monitoring log messages comprises: processing the network monitoring log messages to determine repeating constant portions across the network monitoring log messages and information that is specific to each network monitoring log message; and identifying the repeating constant portions as the log template and the information that is specific to each network monitoring log message as parameters of the log template. In one implementation, identifying is based on a parsing tree that encodes nodes of the parsing tree with constant tokens of the network monitoring log messages to create the log template.

According to the implementations herein, an illustrative tangible, non-transitory, computer-readable medium having computer-executable instructions stored thereon that, when executed by a processor on a computer, cause the computer to perform a method comprising: determining a log template mapped from network monitoring log messages; generating a visualization of the log template including interactive graphical representations of a detection frequency for the log template, a frequency distribution of parameter values per parameter for the log template, and relationships between parameter values across different parameters for the log template; filtering data included in the visualization based on a user selection of a portion of a particular graphical representation; and modifying, based on user feedback on the visualization, generation of subsequent visualizations of log templates.

According to the implementations herein, an illustrative apparatus comprising: one or more network interfaces to communicate with a network; a processor coupled to the one or more network interfaces and configured to execute one or more processes; and a memory configured to store a process that is executable by the processor, the process, when executed, configured to: determine a log template mapped from network monitoring log messages; generate a visualization of the log template including interactive graphical representations of a detection frequency for the log template, a frequency distribution of parameter values per parameter for the log template, and relationships between parameter values across different parameters for the log template; filter data included in the visualization based on a user selection of a portion of a particular graphical representation; and modify, based on user feedback on the visualization, generation of subsequent visualizations of log templates.

While there have been shown and described illustrative implementations herein that provide actionable and interactive log visualizations, it is to be understood that various other adaptations and modifications may be made within the spirit and scope of the implementations herein. For example, while certain implementations herein are described herein with respect to using the techniques herein for certain purposes, the techniques herein may be applicable to any number of other use cases, as well. In addition, while certain types of graphical formats are discussed herein, the techniques herein may be used in conjunction with any graphical format.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
determining, by a process, a log template mapped from network monitoring log messages;
generating, by the process, a visualization of the log template including interactive graphical representations of a detection frequency for the log template, a frequency distribution of parameter values per parameter for the log template, and relationships between parameter values across different parameters for the log template;
filtering, by the process, data included in the visualization based on a user selection of a portion of a particular graphical representation; and
modifying, by the process and based on user feedback on the visualization, generation of subsequent visualizations of log templates.

2. The method as in claim 1, wherein an interactive graphical representation of the relationships between parameter values across the different parameters for the log template is a parallel coordinate chart.

3. The method as in claim 2, wherein a graphical property of connecting elements between the parameter values across the different parameters corresponds to a frequency of a corresponding parameter combination in the log template.

4. The method as in claim 1, wherein the visualization of the log template further includes a log table for each of the network monitoring log messages included in the interactive graphical representations.

5. The method as in claim 1, wherein a portion of the parameter values are categorical.

6. The method as in claim 1, further comprising:
disabling, based on the user selection indicating that a particular parameter is irrelevant, a graphical representation of a frequency distribution of a particular parameter value for the log template and a graphical representation of a relationship between parameter values for that particular parameter for the log template.

7. The method as in claim 1, wherein the user selection of the portion of the particular graphical representation includes a selection of a region of the particular graphical representation corresponding to a specific time window.

8. The method as in claim 7, wherein filtering the data included in the visualization includes highlighting a region of another graphical representation that corresponds to the specific time window.

9. The method as in claim 1, wherein the user selection of the portion of the particular graphical representation includes a selection of parameter value ranges within the particular graphical representation.

10. The method as in claim 1, further comprising:
updating a log table included in the visualization to depict only log message data with parameter values within selected parameter value ranges.

11. The method as in claim 1, wherein the user selection of the portion of the particular graphical representation includes a selection of a first region of the particular graphical representation corresponding to a first specific time window and a section of a second region of the particular graphical representation corresponding to a second specific time window.

12. The method as in claim 11, wherein a color coding that differentiates data associated with the first specific time window from data associated with the second specific time window is applied to the interactive graphical representations of the detection frequency for the log template, the frequency distribution of parameter values per parameter for the log template, and the relationships between parameter values across different parameters for the log template.

13. The method as in claim 1, wherein the user feedback includes one or more of: a user customization of a graphical representation; a user rating of an element of the visualization; or a customized log template for log message mapping.

14. The method as in claim 1, further comprising:
modifying, based on the user feedback, an inferential data model utilized to identify constant and parametric components within network monitoring log messages for log template mapping.

15. The method as in claim 1, wherein determining the log template mapped from network monitoring log messages comprises:
processing the network monitoring log messages to determine one or more repeating constant portions across the network monitoring log messages and information that is specific to each network monitoring log message; and
identifying the one or more repeating constant portions as the log template and the information that is specific to each network monitoring log message as parameters of the log template.

16. The method as in claim 15, wherein identifying is based on a parsing tree that encodes nodes of the parsing tree with constant tokens of the network monitoring log messages to create the log template.

17. A tangible, non-transitory, computer-readable medium having computer-executable instructions stored thereon that, when executed by a processor on a computer, cause the computer to perform a method comprising:
determining a log template mapped from network monitoring log messages;
generating a visualization of the log template including interactive graphical representations of a detection frequency for the log template, a frequency distribution of parameter values per parameter for the log template, and relationships between parameter values across different parameters for the log template;
filtering data included in the visualization based on a user selection of a portion of a particular graphical representation; and
modifying, based on user feedback on the visualization, generation of subsequent visualizations of log templates.

18. The tangible, non-transitory, computer-readable medium as in claim 17, wherein an interactive graphical representation of the relationships between parameter values across the different parameters for the log template is a parallel coordinate chart.

19. The tangible, non-transitory, computer-readable medium as in claim 17, wherein the method further comprises:
modifying, based on the user feedback, an inferential data model utilized to identify constant and parametric components within network monitoring log messages for log template mapping.

20. An apparatus, comprising:
one or more network interfaces to communicate with a network;
a processor coupled to the one or more network interfaces and configured to execute one or more processes; and
a memory configured to store a process that is executable by the processor, the process, when executed, configured to:
determine a log template mapped from network monitoring log messages;
generate a visualization of the log template including interactive graphical representations of a detection frequency for the log template, a frequency distribution of parameter values per parameter for the log template, and relationships between parameter values across different parameters for the log template;
filter data included in the visualization based on a user selection of a portion of a particular graphical representation; and
modify, based on user feedback on the visualization, generation of subsequent visualizations of log templates.
